(19) United States
(12) Patent Application Publication
(10) Pub. No.: US 2007/0218915 A1
(43) Pub. Date: Sep. 20, 2007

(54) WIRELESS COMMUNICATION RESOURCE ALLOCATION AND RELATED SIGNALING

(75) Inventors: Yunsong Yang, San Diego, CA (US); Anthony C.K. Soong, Plano, TX (US); Jianmin Lu, San Diego, CA (US); Patrick Hosein, San Diego, CA (US)

Correspondence Address: AKIN GUMP STRAUSS HAUER & FELD, LLP, P O BOX 688, DALLAS, TX, 75313-0688, US

(73) Assignee: FutureWei Technologies, Inc., Plano, TX (US)

(21) Appl. No.: 11/688,721

(22) Filed: Mar. 20, 2007

Related U.S. Application Data
(60) Provisional application No. 60/784,584, filed on Mar. 20, 2006.

(51) Int. Cl. H04Q 7/20

(52) U.S. Cl. 455/450

(57) ABSTRACT

A method and apparatus of signaling radio resource allocation in a wireless communication system is disclosed. The method comprises: dividing the radio resource into units of a first type of assignment and of a second type; using the first type of assignment units for the first type of assignment; using the second type of assignment units for the second type of assignment; multiplexing the first type and the second type of assignments in the same frame; indicating the assignment for each of a plurality of mobile stations by a base station; determining the multiplexing mode by the base station; and communicating the multiplexing mode to each of the plurality of mobile stations by the base station.

### PRIORITY CLAIM

This application claims the priority of U.S. Provisional Application No. 60/784,584, entitled “WIRELESS COMMUNICATION RESOURCE ALLOCATION AND RELATED SIGNALING”, filed Mar. 20, 2006, hereof and hereby expressly incorporated be reference herein.

### CROSS-REFERENCE TO RELATED APPLICATIONS

The present Application for Patent is related to the co-pending U.S. Patent Application having Attorney Docket No. 683440.0057, entitled “METHOD AND APPARATUS FOR WIRELESS RESOURCE ALLOCATION”, filed Feb. 26, 2007, accorded U.S. Ser. No. 11/679,060, assigned to the assignee hereof, expressly incorporated by reference herein.

### TECHNICAL FIELD OF THE INVENTION

The present invention relates generally to allocation of radio resource for transmission in a wireless communication system. Specifically, the present invention relates to a novel method of signaling the allocation of radio resource for transmission in orthogonal frequency division multiplexing (OFDM) and orthogonal frequency division multiple access (OFDMA) communication systems.

### BACKGROUND

In a wideband wireless communications system, the signal tends to suffer from frequency selective fading due to multi-path interference. An OFDM system has been proposed to overcome the problem of frequency selective fading by dividing the total bandwidth into a plurality of subcarriers such that the bandwidth on each subcarrier is sufficiently narrow to enable the data modulation symbols carried by that subcarrier to experience relatively flat fading.

The OFDMA system uses an OFDM modulation technique to multiplex the traffic data of a plurality of mobile stations in both frequency and time. In a cellular network or an ad hoc network, some mobile stations may be physically moving at a relatively fast rate of speed, while others are more stationary when they transmit or receive data. Some mobile stations experience severe multi-path, while others have a nearly line-of-sight channel with a base station antenna. Therefore, two assignment methods have been proposed for an OFDMA-based wireless communications system. One assignment method, called localized resource channel (LRCH) assignment, assigns the subcarriers that are contiguous in both time and frequency to one mobile station. Another assignment method, called distributed resource channel (DRCH) assignment, assigns the subcarriers that are scattered in both time and frequency to one mobile station.

FIGS. 1A and 1B illustrate examples of two modes of multiplexing these two types of assignments in one frame. In the first multiplexing mode as shown in FIG. 1A, users, which are also known as mobile stations, A, B, C, and D are assigned with the LRCH assignments. Users E and F are assigned with DRCH assignments. The subcarrier-time bins assigned to users E and F overlap with some but not all subcarrier-time bins assigned to users A, B, C, and D. In the first multiplexing mode, users A, B, C, and D don't use those overlapped subcarrier-time bins. In the second multiplexing mode, as shown in FIG. 1B, only user C is assigned with the LRCH assignment. The other users, including users A and B, are assigned with the DRCH assignments. The subcarrier-time bins assigned to the users with the DRCH assignments do not overlap with the subcarrier-time bins assigned to user C. This is done by re-arranging the scattering pattern of the subcarrier-time bins assigned to the users with the DRCH assignments.

A signaling mechanism is needed for the base station to inform all mobile stations which multiplexing mode is to be used in the current frame. When a first multiplexing mode is being used, the base station needs to inform all mobile stations that are scheduled with the LRCH assignments about which subcarrier-time bins are assigned to the DRCH assignments so that the mobile stations that are scheduled with the LRCH assignments avoid using those subcarrier-time bins. When a second multiplexing mode is being used, the base station needs to inform all mobile stations that are scheduled with the DRCH assignments about which subcarrier-time bins are assigned to the LRCH assignments so that the mobile stations that are scheduled with the DRCH assignments re-arrange the scattering pattern and avoid using those subcarrier-time bins. It has been proposed that a common signaling channel called forward primary data control channel (F-PDCCH) performs the above functions.

Further, a signaling mechanism is needed for the base station to inform each scheduled mobile station about what frequency-time resources, whether with the LRCH or the DRCH assignment type, are assigned to the mobile station. It has been proposed that a dedicated signaling channel called forward secondary data control channel (F-SDCCH) performs the above functions

### SUMMARY OF THE INVENTION

It is an objective of the present invention to provide a method and apparatus for the base station to indicate the assignments to the mobile stations reliably while minimizing the signaling overhead.

It is another objective of the present invention to provide a method and apparatus for the mobile station to detect the assignment from the base station reliably.

In one aspect of present invention, a method and apparatus of communicating radio resource allocation in a wireless communication system is disclosed. The method comprises dividing the radio resource into a first type of assignment units; dividing the radio resource into a second type of assignment units; using the first type of assignment units for the first type of assignment; using the second type of assignment units for the second type of assignment; multiplexing the first type and the second type of assignments in the same frame; indicating the multiplexing mode to each of the plurality of mobile stations by the base station using the last assignment message of the second type of assignments; indicating the assignment for each of a plurality of mobile stations by a base station; indicating the overlapped region using the last assignment message of the second type of assignments so that all mobile stations scheduled with the first type of assignment avoid using the overlapped region when the first multiplexing mode is used; and indicating the overlapped region using all the first type of assignment message so that all mobile stations scheduled with the second type of assignment avoid using the overlapped region when the second multiplexing mode is used.

### BRIEF DESCRIPTION OF THE DRAWINGS

FIGS. 1A and 1B illustrate two existing modes of multiplexing two types of radio resource assignments in one frame.

FIG. 2 illustrates a tree structure of combining smaller resource assignment units into a bigger resource assignment unit and the denotation of the tree nodes.

FIG. 3 shows an exemplary channel structure for the control channel that carries the assignment messages according to the disclosure in the cross-referenced application in connection with the present invention.

FIG. 4 illustrates an embodiment of the base station's procedure for sending the assignment messages and data packets according to the present invention.

FIG. 5 illustrates an embodiment of the mobile station procedure for detecting the assignment messages and data packets according to the present invention.

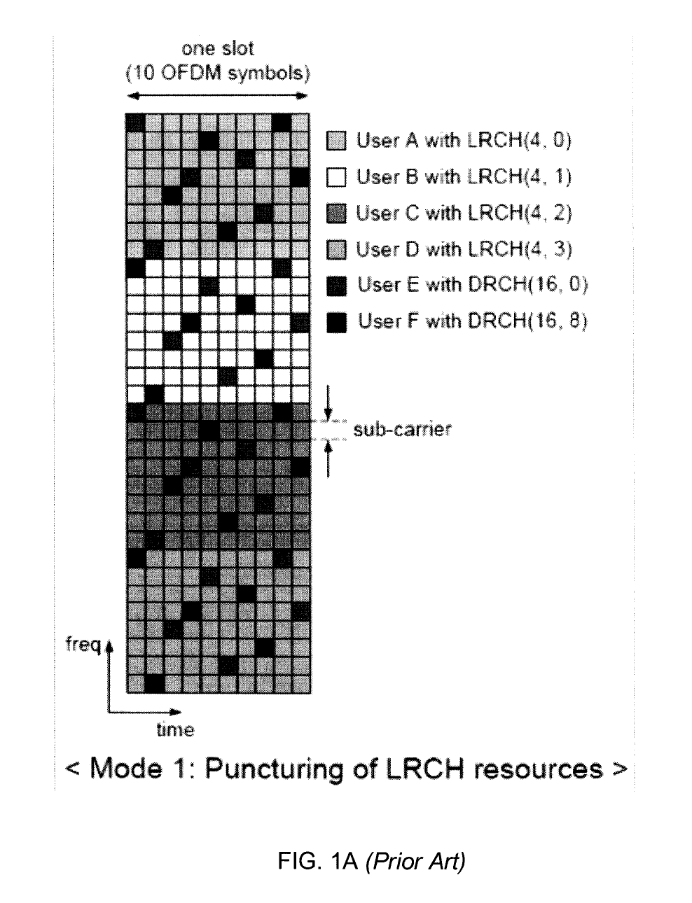

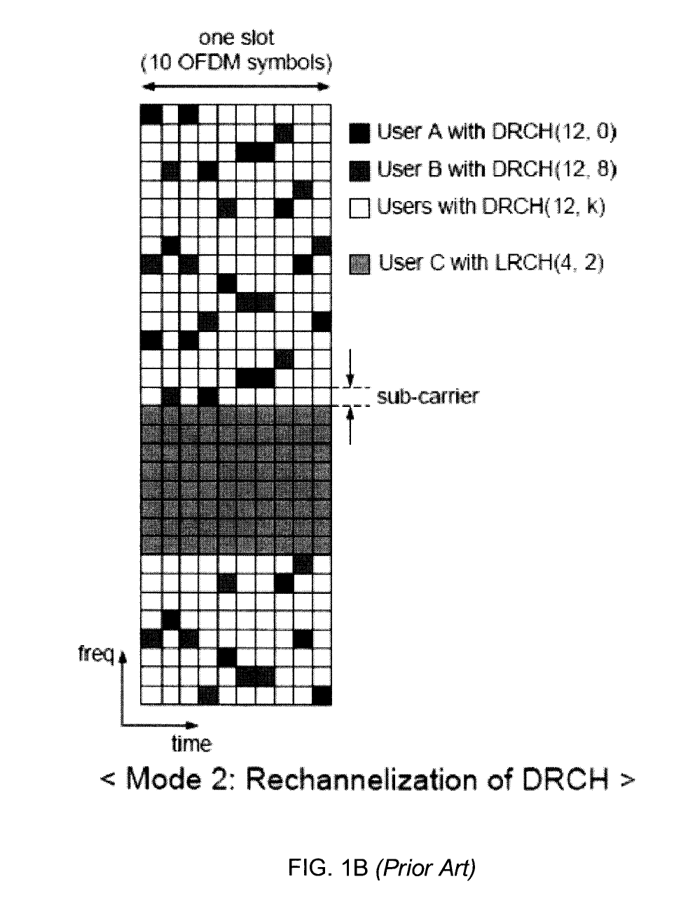

### DETAILED DESCRIPTION

The present disclosure can be described by the embodiments given below. It is understood, however, that the embodiments below are not necessarily limitations to the present disclosure, but are used to describe a typical implementation of the invention.

The present invention provides a unique method and system for Wireless Communication Resource Allocation and Related Signaling. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

According to the disclosure in the cross-referenced application, entitled “Method and Apparatus for Wireless Resource Allocation”, Table 1 below shows an exemplary denotation of the radio resources assigned with the LRCH assignment according to one embodiment of the present invention, the total bandwidth of the exemplary system is 5 MHz with a sampling rate of 4.9152 Msps (million samples per second). The fast Fourier transformation (FFT) size is 512, which is also the total number of subcarriers in frequency. The 512 subcarriers are divided into 32 contiguous minimum localized assignment units in frequency. Each minimum localized assignment unit consists of 16 contiguous subcarriers over a plurality of contiguous OFDM symbols in time within a frame. In a system where the control channels, such as the F-SSCHs that carry the assignment messages for each frame, are frequency-division multiplexed (FDM) with the data channels, some minimum LRCH assignment units are assigned for the control channels and cannot be used for the data channels. In a system where the control channels are time-division multiplexed (TDM) with the data channels, which is the case illustrated in Table 1, some OFDM symbols in a frame, for example, OFDM Symbol 0, is assigned for the control channels, while OFDM Symbols 1 to 7 are used for the data channels. In addition, the solid-shaded area in Table 1 may be used for a Guard Band and thus, not available for the data channels. The Guard Band in the example given in Table 1 corresponds to subcarriers 224 to 287. Subcarrier 0 is the Direct Current (DC) tone of the baseband signal.

TABLE 1

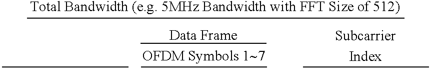

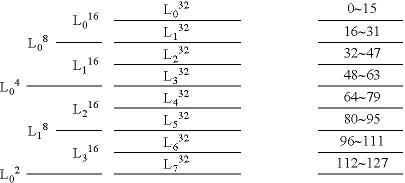

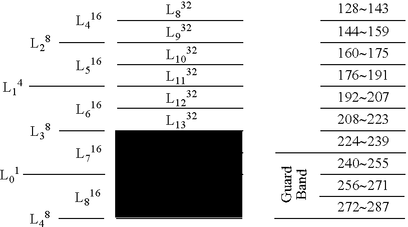

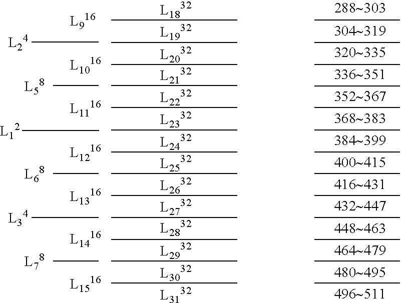

As shown in Table 1 above, an LRCH assignment unit is denoted as Lₖ^{N}, representing the kth divided assignment unit if the total available resource is divided into N equal-sized LRCH assignment units. In Table 1, two smaller LRCH assignment units with the same size and certain relationship in the indices of the LRCH assignment units can be combined into a larger LRCH assignment unit.

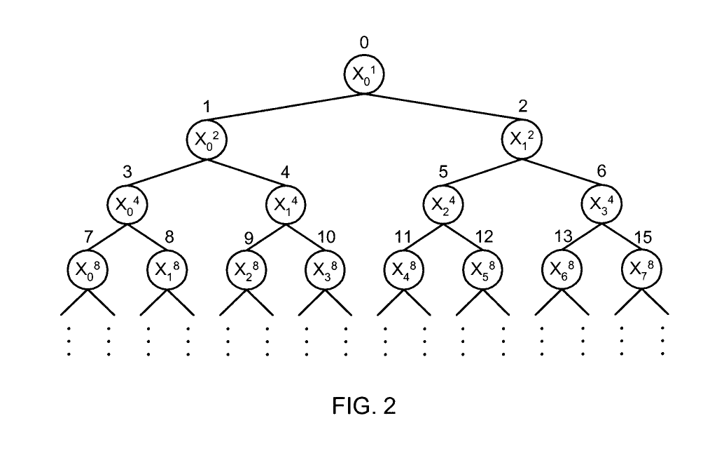

According to the disclosure in the cross-referenced application, entitled “Method and Apparatus for Wireless Resource Allocation”, FIG. 2 further illustrates, with an exemplary tree structure, how two smaller LRCH assignment units with the same size and certain relationship in the indices of the two assignment units can be combined into a larger LRCH assignment unit. Replacing the letter “X” with “L”, each circle, denoting a tree node, in FIG. 2 represents an LRCH assignment unit. Each tree node can be represented by a combination of N and k as defined above. To reduce the signaling overhead, the representation of a tree node can be simplified as one number, called Node Index (NodeID), which is above each circle as shown in FIG. 2. The generalized rule of combining two smaller LRCH assignment units into a larger LRCH assignment unit is illustrated in the following equation:
Lₖ^{N}=L₂ₖ^{2N}+L₂ₖ₊₁^{2N} (1)

Table 2 below shows an exemplary denotation of the radio resources with the DRCH assignment for the same 5 MHz system according to one embodiment of the present invention. For the first OFDM symbol in the data frame, starting from subcarrier 0, which is the DC tone, every 32 contiguous subcarriers form a group, and the subcarriers within each group in the first OFDM symbol are denoted according the first column in Table 2 in a repeated manner. For the second OFDM symbol in the data frame, starting from subcarrier 0, every 32 contiguous subcarriers form a group, and the subcarriers within each of the 16 groups in the second OFDM symbol are denoted according to the second column in Table 2, which is a cyclically rotated version of the first column with an offset of, for example, four subcarriers. The subcarriers for the third OFDM symbol in the data frame are denoted in a similar cyclically rotated manner. The same is true for the fourth OFDM symbol, and so on. The subcarriers denoted with the same N and k in Dₖ^{N} represent the kth divided assignment unit if the total available resource is divided into N equal-sized DRCH assignment units.

TABLE 2

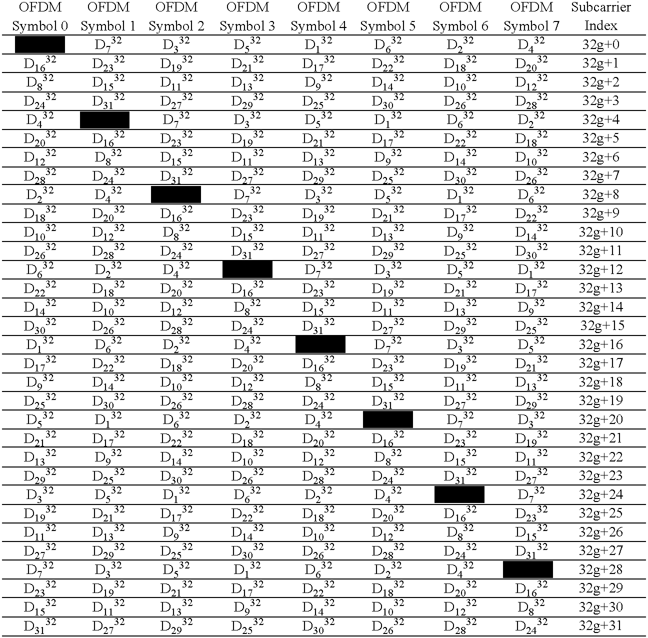

where g is an integer and g=0,1, . . . , 15.

In Table 2, two smaller DRCH assignment units with the same size and certain relationship in their indices can be combined into a larger DRCH assignment unit. Replacing the letter “X” with “D”, the same tree structure and denotation of tree nodes as shown in FIG. 2 can be used to illustrate the combining of the DRCH assignment units. The generalized rule of combining two smaller DRCH assignment units into a larger DRCH assignment unit is illustrated in the following equation:
Dₖ^{N}=D₂ₖ^{2N}+D₂ₖ₊₁^{2N} (2)

In the example shown in Table 2, the incremental offset of the cyclic rotation in denoting a 32-subcarrier group is constant and regular. A person of ordinary skill in the art will understand that any irregular offset pattern can be used between the OFDM symbols.

Because the denotation of the subcarriers of one group is repeated 16 times in one OFDM symbol in the example, the subcarriers within the same DRCH assignment unit are evenly spaced in frequency and scattered across time. In another embodiment, the 16 groups within each OFDM symbol are further indexed from 0 to 15. The offset of the cyclic rotation is not only a function of the OFDM Symbol Index, the base station index, and the current frame number, but also a function of the group index. In this embodiment, the subcarriers within the same DRCH assignment unit are not evenly spaced in frequency, enabling interference randomization.

In yet another embodiment, the denotation of a 32-subcarrier group is not a simple cyclically-rotated version but a randomly permutated version of the 32-subcarrier group in the first OFDM symbol as a function of the OFDM Symbol Index, the base station index, and the current frame number. The permutation pattern is repeated 16 times for the 16 groups within an OFDM symbol. In this way, the subcarriers within the same DRCH assignment unit are evenly spaced in frequency and scattered across time. In yet another embodiment according to the present invention, the 16 groups within each OFDM symbol are indexed from 0 to 15, and the permutation pattern is a function of both the OFDM Symbol Index, the base station index, the current frame number, and the group index. In this embodiment, the subcarriers within the same DRCH assignment unit are not evenly spaced in frequency, achieving interference randomization.

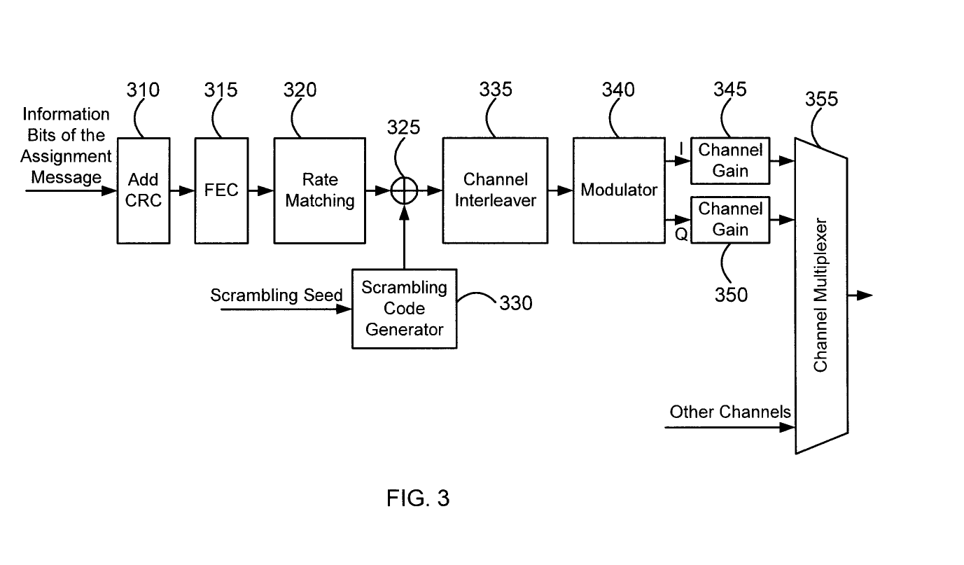

According to the disclosure in the cross-referenced application, entitled “Method and Apparatus for Wireless Resource Allocation”, FIG. 3 illustrates an exemplary channel structure for the forward shared scheduling channel (F-SSCH) that sends the assignment messages to the mobile stations according to the present invention. The assignment message contains at least a field for Media Access Control Index (MACID) to identify the intended mobile station, a field for Node Index (NodeID) to identify the assigned radio resource in time and frequency, a field for Assignment Type to identify whether the assignment is an LRCH assignment or a DRCH assignment, and a field of Packet Format (PF) to identify the encoder packet size, modulation level, and code rate of the data packet. A person of ordinary skill in the art will understand that the assignment message may contain other fields including, but not limited to, fields for message type and an indication of multiple antenna mode.

According to the disclosure in the cross-referenced application, entitled “Method and Apparatus for Wireless Resource Allocation”, the field of Assignment Type in the F-SSCH can be eliminated in a simplified scheme by limiting the localized assignment units to those with a first set of sizes and limiting the distributed assignment units to those with a second set of sizes, wherein none of the sizes in the first set exists in the second set and none of the sizes in the second set exists in the first set. For example, in the 5 MHz system illustrated above, the localized assignment units can be limited to L₀¹, L₁², Lⱼ⁴, and Lₘ⁸, while the distributed assignment units can be limited to Dₓ¹⁶ and D_{y}³², where i, j, m, x, y are integers, and 0≦i≦1, 0≦j≦3, 0≦m≦7, 0≦x≦15, and 0≦y≦31. Therefore, the assignment size implies which assignment type is used, and thus there is no need to have an explicit field of Assignment Type in the F-SSCH.

Referring again to FIG. 3, the Cyclic Redundant Check (CRC) bits are first added to the information bits of the assignment message by the CRC element 310. The forward error correction (FEC) element 315 adds error correction coding to the output sequence of the CRC element 310. Then, a rate matching element 320 repeats and/or punctures the encoded bits from the encoder in order to match the rate on the F-SSCH to a certain fixed rate. A scrambler 325 then scrambles the output sequence from the rate matching element 320 with a scrambling code that is generated from scrambling code generator 330. The scrambling code generator 330 is a PN register that is seeded with the channel identity of the F-SSCH, the current frame number, and optionally the scrambling type. The scrambled sequence is interleaved by channel interleaver 335. The interleaved sequence is then modulated by modulator 340. The in-phase (I) and quadrature (Q) outputs of modulator 340 are then gain-controlled by the channel gain elements 345 and 350 respectively. The complex output signal is then multiplexed with the other channels by the channel multiplexer 355 using Code Division Multiple Access (CDMA), Time Division Multiple Access (TDMA), OFDMA, or any combination of the above.

According to one aspect of the present invention, at least one DRCH assignment and at least one LRCH assignment can be multiplexed in the same frame. Each DRCH assignment can have different assignment sizes, and each LRCH assignment can have difference assignment sizes.

According to another aspect of the present invention, the base station assigns the DRCH assignments according to the sequence of the minimum DRCH assignment units that the DRCH assignments cover. For example, in the 5 MHz system illustrated in Table 2, the following three DRCH assignments, D₀⁸, D₂¹⁶, and D₆³², leave no vacant subcarriers in the resource assigned. However, the following three DRCH assignments, D₀⁸, D₄¹⁶, and D₁₀³², would leave some vacant subcarriers in the resource assigned.

According to yet another aspect of the present invention, a Last DRCH Assignment is defined as the DRCH assignment that covers the minimum DRCH assignment unit, for example Dₖ³², with the largest index k among all DRCH assignments. Therefore, the NodeID field in the Last DRCH Assignment message implicitly indicates all the DRCH assignment units assigned to the mobile station that are scheduled with the DRCH assignments. The assignment message for the Last DRCH Assignment is sent on the first F-SSCH with sufficient power by the Channel Gain elements 345 and 350 such that all scheduled mobile stations can decode the Last DRCH Assignment message correctly. Therefore, in the first multiplexing mode, since each mobile station understands the group offset values or group permutation pattern as described above, as a result of the Last DRCH assignment message, each mobile station that is scheduled with the LRCH assignment in the same frame will recognize subcarrier-time bins that are assigned to the mobile station and are overlapped with the DRCH assignments. According to the first mode of multiplexing, the mobile stations that are scheduled with the LRCH assignments will not use those overlapped subcarrier-time bins when retrieving the modulation symbols for each corresponding data packet.

The first F-SSCH can be distinguished from the other F-SSCHs by using a special orthogonal code, scrambling code, frequency subband, subfield within a long field of assignment message, time, or time-frequency bin, which is specified by the individual base station, can be different from base station to base station, and is communicated to all mobile stations by signaling messages. If there is no DRCH assignment in the frame, the first F-SSCH can be used for carrying an LRCH assignment message. In this case, because all mobile stations that are scheduled with the LRCH assignment need to detect correctly that the first F-SSCH is carrying an LRCH assignment message, the first F-SSCH should be sent with sufficient power by the Channel Gain elements 345 and 350 to ensure all mobile stations that are scheduled with the LRCH assignment can detect it correctly. Furthermore, selecting the mobile station with the worst channel condition among all mobile stations that are scheduled with the LRCH assignment can help to utilize the base station transmit power more efficiently, but this is not required. In the first multiplexing mode, all DRCH assignment messages except the Last DRCH Assignment message and all LRCH assignment messages can be sent in a dedicated manner, i.e. be sent with sufficient power by the Channel Gain elements 345 and 350 to ensure that the target mobile station can decode the assignment message correctly, for example, based on the channel quality feedback from the target mobile station.

According to another aspect of the present invention, the Last DRCH assignment message also serves as the indicator of which multiplexing mode is used in the frame. More specifically, when the number of subcarriers assigned to the DRCH assignments within each 32-subcarrier group exceeds a mode-switching threshold, an enhanced second multiplexing mode is used. Otherwise, the first multiplexing mode is used. In the enhanced second mode of multiplexing, the overlapped subcarrier-time bins are assigned to the mobile stations that are scheduled with the LRCH assignment, and the mobile stations that are scheduled with the DRCH assignments cannot use those overlapped subcarrier-time bins. In order for all the scheduled mobile stations to understand that the second mode is being used, the first F-SSCH that carries the Last DRCH Assignment message should be sent with sufficient power by the Channel Gain elements 345 and 350 to ensure all scheduled mobile stations can decode the Last DRCH Assignment message correctly. Using the Last DRCH Assignment message for the mobile station with the worst channel condition among all mobile station that are scheduled with the DRCH assignment can help to utilize the base station transmit power more efficiently, as mentioned above, but it is not required. In addition, in the enhanced second mode of multiplexing, in order for all mobile stations scheduled with the DRCH assignment to understand which subcarrier-time bins are assigned for the LCRH assignments, LRCH assignment message should be sent with sufficient power by the Channel Gain elements 345 and 350 to ensure that all mobile stations that are scheduled with the DRCH assignment to decode the LRCH assignment message correctly. In the second mode of multiplexing, all DRCH assignment messages except the Last DRCH Assignment message can be sent in a dedicated manner, i.e. sent with sufficient power by Channel Gain elements 345 and 350 to ensure the target mobile station can decode the assignment message correctly (e.g., based on the channel quality feedback from the target mobile station).

In addition, when the enhanced second mode of multiplexing is used and there is no LRCH assignment being scheduled in the same frame, a mobile station that is scheduled with the DRCH assignment may not be able to recognize whether the mobile station has missed the detection of any LRCH assignment messages or there is in fact no LRCH assignment.

According to yet another aspect of the present invention, if there is at least one DRCH assignment and at least one LRCH assignment in the frame, the Last DRCH Assignment message is sent on the first F-SSCH and scrambled with the first scrambling method. If there is at least one DRCH assignment and no LRCH assignment, the Last DRCH Assignment message is sent on the first F-SSCH and scrambled with the second scrambling method.

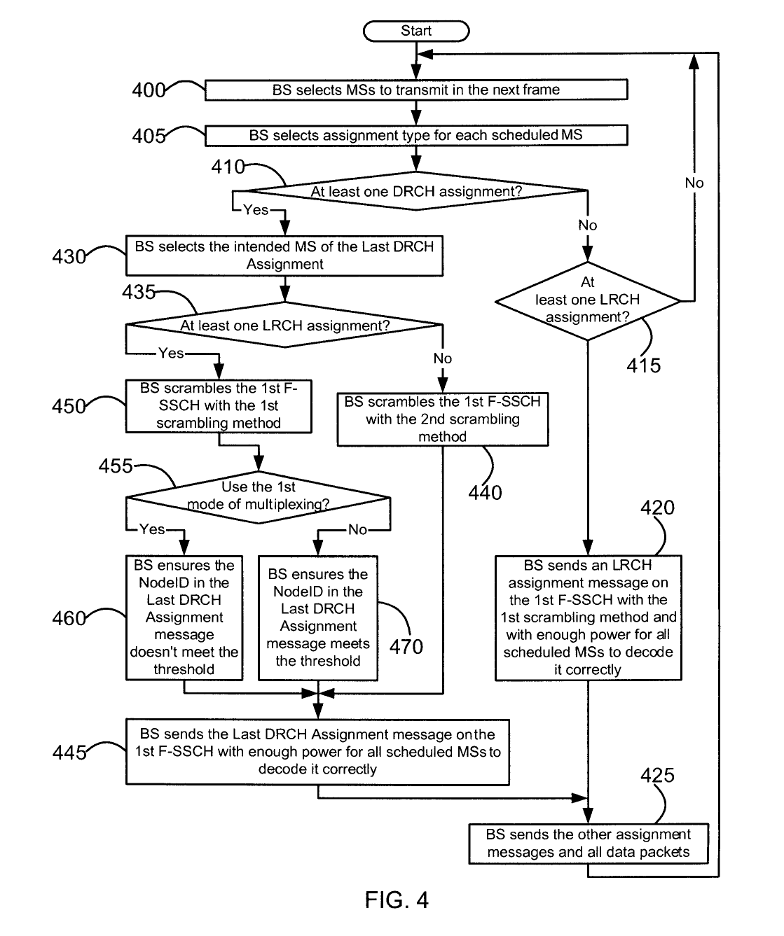

FIG. 4 illustrates an embodiment of the base station procedure for sending the assignment messages and data packets according to the present invention. As shown in FIG. 4, the base station in step 400 selects which mobile stations are to be scheduled for transmission in the next frame and which type of assignment is used for each of those scheduled mobile stations in step 405. In step 410, the base station determines if there is at least one mobile station scheduled with the DRCH assignment. If there is no mobile station scheduled with the DRCH assignment, the base station further determines if there is at least one mobile station that is scheduled with the LRCH assignment in step 415. If no, the base station waits until the next frame arrives. If yes, in step 420 the base station sends an LRCH assignment message on the first F-SSCH with the first scrambling method and with sufficient power for all scheduled mobile stations to decode it correctly. Then, in step 425 the base station sends the other assignment messages in a dedicated manner as described above and all data packets, and the base station waits until the next frame arrives. If the base station determines in step 410 that there is at least one mobile station scheduled with the DRCH assignment, the base station selects a mobile station that is scheduled with the DRCH assignment to be the intended mobile station for the Last DRCH Assignment in step 430. For example, the base station can select the mobile station with the worst channel condition among all mobile stations that are scheduled with the DRCH assignment to be the intended mobile station of the Last DRCH Assignment. This selection method enables the base station to transmit power more efficiently, but it is not required. Next, in step 435, the base station determines if there is at least one mobile station scheduled with the LRCH assignment. If there is no mobile station scheduled with the LRCH assignment, the base station scrambles the first F-SSCH with the second scrambling method in step 440.

Then, the base station sends the Last DRCH Assignment message on the first F-SSCH with sufficient power for all scheduled mobile stations to decode it correctly in step 445. Then, the base station sends the other assignment messages in a dedicated manner and all data packets in step 425 and the base station waits until the next frame arrives. If the base station determines that there is at least one mobile station scheduled with the LRCH assignment in step 435, the base station scrambles the first F-SSCH with the first scrambling method in step 450. Then, in step 455, the base station determines which multiplexing mode is to be used in the frame. If the first multiplexing mode is to be used, the base station ensures that the NodeID in the Last DRCH Assignment message does not exceed the mode-switching threshold in step 460. If the second multiplexing mode is to be used, the base station ensures that the NodeID in the Last DRCH Assignment message exceeds the mode-switching threshold in step 470. Then the base station sends the Last DRCH Assignment message on the first F-SSCH with sufficient power for all scheduled mobile stations to decode it correctly in step 445. The base station sends the other assignment messages and all data packets in step 425 and the based station waits until the next frame arrives.

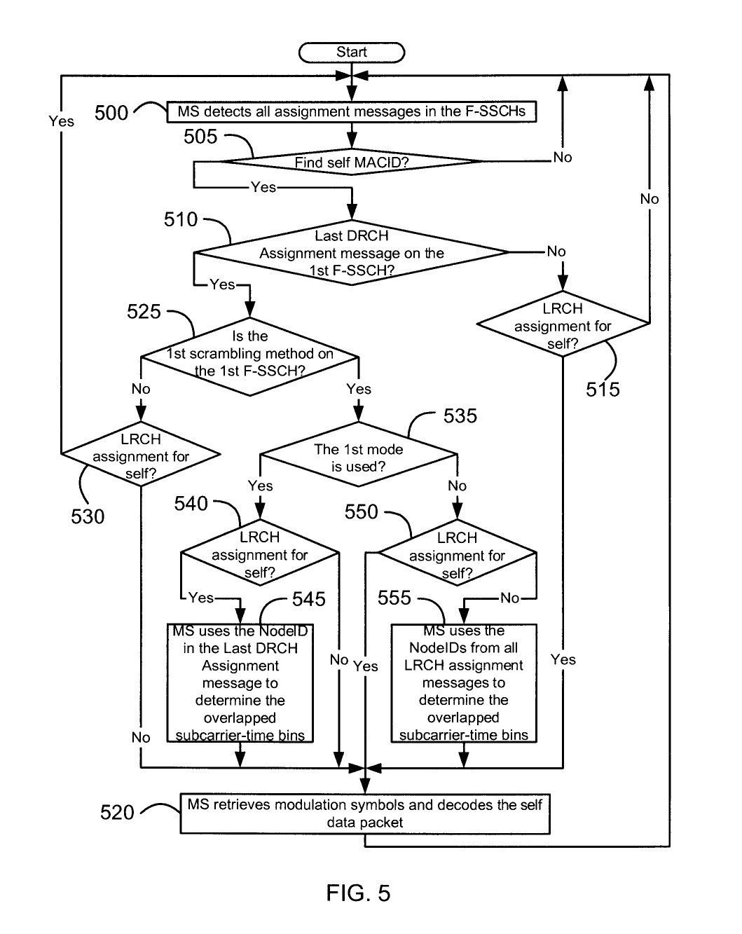

FIG. 5 illustrates an embodiment of the mobile station procedure for detecting the assignment messages and data packets according to the present invention. Referring to FIG. 5, the mobile station first detects all assignment messages on all F-SSCHs in step 500. Then, the mobile station determines if the MACID of the mobile station has been found in any of these assignment messages in step 505. If no, the mobile station waits until the next frame arrives. If yes, the mobile station determines if there is a DRCH assignment message on the first F-SSCH in step 510. If no, the mobile station determines if the assignment for the mobile station is an LRCH assignment in step 515. If no, a detection error is shown and the mobile station waits until the next frame arrives, because the assignment for this mobile station can not be a DRCH assignment when the assignment on the first F-SSCH is not a DRCH assignment. If the mobile station determines that the assignment for the mobile station is an LRCH assignment in step 515, the mobile station uses the NodeID in the assignment message of the mobile station to retrieve the modulation symbols of data packet for the mobile station and decodes that data packet in step 520. Then, the mobile station waits until the next frame arrives. If the mobile station determines that there is a DRCH assignment message on the first F-SSCH in step 510, this DRCH assignment message is the Last DRCH Assignment message. The mobile station then determines if the first F-SSCH is scrambled with the first scrambling method in step 525. If no, the mobile station then determines if the assignment for the mobile station is an LRCH assignment in step 530. If yes, a detection error is shown, and the mobile station waits until the next frame arrives because if the mobile station determines that the first F-SSCH is scrambled with the second scrambling method in step 525, there is no LRCH assignment in the frame. If the mobile station determines that the assignment for the mobile station is an LRCH assignment in step 530, the mobile station uses the NodeID in the assignment message of the mobile station to retrieve the modulation symbols of the data packet for the mobile station and decodes that data packet in step 520.

Then, the mobile station waits until the next frame arrives. If the mobile station determines that the first F-SSCH is scrambled with the first scrambling method in step 525, the mobile station determines if the first multiplexing mode is used in the frame in step 535. If yes, the mobile station determines if the assignment for the mobile station is an LRCH assignment in step 540. If no, the mobile station uses the NodeID in the assignment message of the mobile station to retrieve the modulation symbols of the data packet for the mobile station and decodes that data packet in step 520. Then, the mobile station waits until the next frame arrives. If yes, the mobile station first uses the NodeID in the Last DRCH Assignment message to determine overlapped subcarrier-time bins in step 545.

Then, the mobile station uses the NodeID in the assignment message of the mobile station excluding the overlapped subcarrier-time bins to retrieve the modulation symbols of the data packet for the mobile station and decodes the data packet in step 520. Then, the mobile station waits until the next frame arrives. If the mobile station determines that the second multiplexing mode is used in the frame in step 535, the mobile station determines if the assignment for the mobile station is an LRCH assignment in step 550. If yes, the mobile station uses the NodeID in the assignment message of the mobile station to retrieve the modulation symbols of the data packet for the mobile station and decodes the data packet in step 520. Then, the mobile station waits until the next frame arrives. If no, the mobile station first uses the NodeIDs in all the LRCH assignment messages to determine the overlapped subcarrier-time bins in step 555. Then, the mobile station uses the NodeID in the assignment message of the mobile station, excluding the overlapped subcarrier- time bins, to retrieve the modulation symbols of the data packet for the mobile station and decodes the data packet in step 520. Then, the mobile station waits until the next frame arrives.

The various illustrative logical blocks, modules, and circuits described in connection with the embodiment disclosed herein may be implemented or performed with, but not limited to, a general purpose processor, a digital signal processor (DSP), an application specific integrated circuit (ASIC), a field programmable gate array (FPGA) or other programmable logic device, discrete gate or transistor logic, discrete hardware components, and any combination thereof designed to perform the functions described herein.

The steps of a method or algorithm described in connection with the embodiments disclosed herein may be implemented or performed directly in hardware, in a software module executed by a processor, or in combination of the two. A software module may reside in, but not limited to, RAM memory, flash memory, ROM memory, EPROM memory, EEPROM memory, registers, and any other form of storage medium in the art.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of assigning radio resource in an OFDMA-based wireless communication system to each of a plurality of mobile stations, the method comprising:
dividing said radio resource into a plurality of assignment units within a frame, each assignment unit being established by either a first type of assignment or a second type of assignment, wherein
an assignment unit established by said first type of assignment comprises a plurality of subcarriers that are contiguous in both time and frequency, and
an assignment unit established by said second type of assignment comprises a plurality of subcarriers that are disjoint in frequency;
communicating an assignment for each of a plurality of mobile stations by a base station;
determining the number of subcarriers assigned under the first type of assignment and the number of subcarriers assigned under the second type of assignment;
multiplexing said assignment units by a second mode of multiplexing if the number of subcarriers assigned under the second type of assignment exceeds a mode-switching threshold; and
multiplexing said assignment units by a first mode of multiplexing if the number of subcarriers assigned under the second type of assignment does not exceed said mode-switching threshold.

2. The method of claim 1, wherein when operating in said first mode of multiplexing, said second type of assignment takes priority over said first type of assignment and when operating in said second mode of multiplexing, said first type of assignment takes priority over said second type of assignment.

3. The method of claim 2, wherein when operating in said first mode of multiplexing, each mobile station scheduled with said first type of assignment defers priority of assignment to the mobile stations having said second type of assignment and when operating in said second mode of multiplexing, each mobile station scheduled with said second type of assignment defers priority of assignment to the mobile stations having said first type of assignment.

4. The method of claim 3, wherein said base station chooses the assignment type based on what application information is being transmitted.

5. The method of claim 4, wherein transmission of delay-insensitive information is performed by mobile stations assigned by said first type of assignment and transmission of delay-sensitive information is performed by mobile stations assigned by said second type of assignment.

6. The method of claim 3, wherein said base station chooses the assignment type based on the channel condition that said mobile stations are experiencing.

7. The method in claim 6, wherein the channel condition is affected by the velocity at which said mobile station is traveling.

8. The method in claim 6, wherein the channel condition is affected by the variance of the measured signal to noise ratio (SNR) across the frequency subcarriers.

9. The method of claim 3, wherein a last assignment message of the second type of assignment implicitly indicates all assignment units assigned with the second type of assignment.

10. The method of claim 9, wherein a NodeID of said last assignment message of the second type of assignment implicitly indicates all assignment units assigned with the second type of assignment.

11. The method of claim 10, wherein the last assignment message of the second type of assignment is identified via a first forward shared scheduling channel (F-SSCH).

12. The method in claim 11, wherein the last assignment message is transmitted with sufficient power to be decoded correctly by all of said mobile stations that are scheduled for transmission.

13. A system of assigning radio resource in an OFDMA-based wireless communication system to each of a plurality of mobile stations, the system comprising:
a base station capable of communicating with a plurality of mobile stations; wherein
said base station divides said radio resource into a plurality of assignment units within a frame, each assignment unit being established by either a first type of assignment or a second type of assignment;
an assignment unit established by said first type of assignment comprises a plurality of subcarriers that are contiguous in both time and frequency;
an assignment unit established by said second type of assignment comprises a plurality of subcarriers that are disjoint in frequency;
an assignment for each of said plurality of mobile stations is communicated by said base station;
said base station determines the number of subcarriers assigned under the first type of assignment and the number of subcarriers assigned under the second type of assignment;
said base station multiplexes said assignment units by a second mode of multiplexing if the number of subcarriers assigned under the second type of assignment exceeds a mode-switching threshold; and
said base station multiplexes said assignment units by a first mode of multiplexing if the number of subcarriers assigned under the second type of assignment does not exceed said mode-switching threshold.

14. The system of claim 13, wherein when operating in said first mode of multiplexing, said second type of assignment takes priority over said first type of assignment and when operating in said second mode of multiplexing, said first type of assignment takes priority of said second type of assignment.

15. The system of claim 14, wherein when operating in said first mode of multiplexing, each mobile station scheduled with said first type of assignment defers priority of assignment to the mobile stations having said second type of assignment and when operating in said second mode of multiplexing, each mobile station scheduled with said second type of assignment defers priority of assignment to the mobile stations having said first type of assignment.

16. The system of claim 15, wherein said base station chooses the assignment type based on what application information is being transmitted.

17. The system of claim 15, wherein said base station chooses the assignment type based on the channel condition that said mobile stations are experiencing.

18. The system of claim 15, wherein a last assignment message of the second type of assignment implicitly indicates all assignment units assigned with the second type of assignment.

19. A system of assigning radio resource in an OFDMA-based wireless communication system to each of a plurality of mobile stations, the system comprising:
a mobile station of a plurality of mobile stations capable of communicating with a base station, wherein
said base station divides said radio resource into a plurality of assignment units within a frame, each assignment unit being established by either a first type of assignment or a second type of assignment;
an assignment unit established by said first type of assignment comprises a plurality of subcarriers that are contiguous in both time and frequency;
an assignment unit established by said second type of assignment comprises a plurality of subcarriers that are disjoint and are equally-spaced in frequency;
an assignment for each of said plurality of mobile stations is communicated by said base station;
said base station determines the number of subcarriers assigned under the first type of assignment and the number of subcarriers assigned under the second type of assignment;
said base station multiplexes said assignment units by a second mode of multiplexing if the number of subcarriers assigned under the second type of assignment exceeds a mode-switching threshold; and
said base station multiplexes said assignment units by a first mode of multiplexing if the number of subcarriers assigned under the second type of assignment does not exceed said mode-switching threshold.

20. The system of claim 19, wherein when operating in said first mode of multiplexing, each mobile station scheduled with said first type of assignment defers priority of assignment to the mobile stations having said second type of assignment and when operating in said second mode of multiplexing, each mobile station scheduled with said second type of assignment defers priority of assignment to the mobile stations having said first type of assignment.

21. The system of claim 20, wherein said base station chooses the assignment type based on what application information is being transmitted.

22. The system of claim 20, wherein said base station chooses the assignment type based on the channel condition that said mobile stations are experiencing.

23. The system of claim 20, wherein a last assignment message of the second type of assignment implicitly indicates all assignment units assigned with the second type of assignment.
